(19) United States
(12) Patent Application Publication
(10) Pub. No.: US 2025/0192325 A1
(43) Pub. Date: Jun. 12, 2025

(54) Protective Device for at Least One Interchangeable Battery Pack of a Battery Powered Machining Device

(71) Applicant: Robert Bosch GmbH, Stuttgart (DE)

(72) Inventors: Mario Ebel, Stuttgart (DE); Andreas Schlegel, Leinfelden-Echterdingen (DE); Frtiz Schlegel, Stuttgart (DE)

(21) Appl. No.: 18/972,908

(22) Filed: Dec. 7, 2024

(30) Foreign Application Priority Data
Dec. 8, 2023 (DE) 10 2023 212 412.2

(51) Int. Cl. H01M 50/267; B25F 5/00; B25F 5/02; H01M 50/247

(52) U.S. Cl. CPC H01M 50/267; B25F 5/006; B25F 5/02; H01M 50/247; H01M 2220/30

(57) ABSTRACT

A protective device for at least one interchangeable battery pack of a battery powered machining device is disclosed, wherein the machining device comprises a housing and an electromechanical interface disposed on the housing, for mounting the at least one interchangeable battery pack without tools, and wherein the protective device is arranged at the electromechanical interface in such a way that it at least partially surrounds the interchangeable battery pack in connection with the housing of the machining device. It is proposed that the protective device is adaptable to a size, in particular a height, of the at least one interchangeable battery pack without tools. Further, the disclosure relates to a system including a protective device according to the disclosure and a battery powered machining device.

This application claims priority under 35 U.S.C. § 119 to application no. DE 10 2023 212 412.2, filed on Dec. 8, 2024 in Germany, the disclosure of which is incorporated herein by reference in its entirety.

The disclosure relates to a protective device for at least one interchangeable battery pack of a battery powered machining device of the type in the disclosure. In addition, the disclosure relates to a system consisting of the protective device according to the disclosure and a battery powered machining device.

### BACKGROUND

Equipping battery powered machining devices with an electromechanical interface on a housing of the machining device provided to mount at least one interchangeable battery pack that can be removed without tools is known in the prior art. To protect the interchangeable battery packs from impacts or blows, a protective device is arranged at the electromechanical interface such that it at least partially surrounds the interchangeable battery pack in conjunction with the housing of the machining device. All known solutions share the characteristic that they are sized to use the maximum permissible interchangeable battery pack, or to use the interchangeable battery pack available from the manufacturer. Thus, the protective devices often increase the size of the machining devices unnecessarily when they are operated with smaller interchangeable battery packs.

DE 10 2022 212 097 A1 shows a protective device, in particular, an impact protection device, for a portable tool, with at least one battery protection unit configured differently from a tool housing, which is configured to protect at least one accumulator of the tool from damage, in particular impact damage, for example, due to an impact as a result of the tool falling, by at least partially surrounding a battery mounting area at least on the side.

A drop frame for a hand-held power tool which surrounds an inserted interchangeable battery pack such that a fall energy is at least partially absorbed by the drop frame and so kept away from the interchangeable battery pack, is known from EP 3 653 343 A1.

DE 10 2018 109 295 A1 shows a protective device for two interchangeable battery packs for supplying power to a hand-held power tool configured as an angle grinder, wherein the protective device is configured as a cage having a protective bracket attached to a housing of the hand-held power tool in such a way that it can pivot.

It is the object of the disclosure to provide a protective device for at least one interchangeable battery pack of a battery powered machining device, which is on the one hand flexibly adaptable to different sizes of interchangeable battery packs and which on the other hand provides good protection against impacts, blows and soiling.

### SUMMARY

To solve the problem, it is provided that the protective device is adaptable to a size, in particular a height, of the at least one interchangeable battery pack without tools. The adaptability of the protective device provides the advantage of a substantially constant enclosure independent of the interchangeable battery pack used. With smaller, interchangeable battery packs, it is thus possible on the one hand to keep the machining device or the protective device as compact as possible, which significantly improves ergonomics and handling, whereas on the other hand, ensuring not only high protection for the at least one interchangeable battery pack against impacts and blows as a result of an improved energy distribution, but also reducing the amount of dirt (dust, moisture, etc.) to which it is exposed during the machining process. Furthermore, the packing dimensions of the machining device can be reduced during transport or storage by the protective device according to the disclosure.

For example, a battery powered machining device is to be a understood as a battery powered machine tool for machining parts using an electrically driven tool. The battery-operated machining device can be designed not only as a hand-held power tool, but also as a stationary machine tool. Typical machine tools in this context include hand-held or stationary drills, screwdrivers, impact drills, planers, angular grinders, oscillating sanders, polishing machines, or the like. However, suitable battery-operated machining devices also include garden tools and construction equipment, e.g. lawn mowers, lawn trimmers, branch saws, tilling and trenching machines, blowers, robotic breakers and excavators, etc., as well as measuring devices, e.g. laser rangefinders, wall scanners, etc. Furthermore, the disclosure is applicable to battery-powered home appliances, such as vacuum cleaners, mixers, etc., and electrically powered two-wheeled vehicles, such as e-bikes, e-scooters, pedelecs, etc.

A size of the at least one interchangeable battery pack may also be understood as a width and/or a depth in addition to its height, depending on its arrangement within the protective device surrounding it. In addition, if there are multiple interchangeable batteries, the size may be based on their overall envelope or the greatest extension of one of the interchangeable batteries to ensure the best possible protection for all mounted interchangeable batteries. Thus, the adjustment of the protective device can also extend in more than one direction. The adjustable size protective device is preferably made of a plastic material, for example PA6GF35, ABS or an elastomer, but can also or alternatively be made of another natural material, a metal (steel, aluminum, etc.) or a mix of materials. It is also conceivable that the protective device does not completely enclose the at least one interchangeable battery pack, but rather that it only protects particularly sensitive locations of the at least one interchangeable battery pack from impacts or blows. Thus, the protective device may be configured as a one-sided or multi-sided open-ended garage, as a fully enclosing housing, or as a frame construction.

In a further development of the disclosure, it is provided that a minimum dimension for the size, in particular the height, of the at least one interchangeable battery pack can be specified depending on a performance capability of the machining device. As a Poka Yoke design, this minimum dimension prevents the use of interchangeable battery packs that are too low in power for a machining device with a certain minimum power requirement. Thus, overheating of an interchangeable battery pack that is too low in power can effectively be prevented.

It is further provided that the protective device comprises a first housing part that can be connected to the housing of the electrical machining device and a second housing part that is mounted in such a way that it can be moved relative to the first housing part. In this context, the designations “the housing part” as part of the entire protective device and “the housing part” as a separate, independent part should not be explicitly differentiated. The partitioning of the protective device into at least two parts allows for a simple and universal attachment of the protective device to housings of different machining devices as previously defined, in conjunction with the ability to adjust to different interchangeable battery packs. The partitioning of the protective device into two housing parts also results in the advantage that the second housing part can be removed and replaced by the user of the machining device or by a service employee as needed. This is particularly customer-friendly in the case of changes by the manufacturer to the interchangeable battery packs, a new battery generation, or a subsequent integration of elements for altering the properties of the interchangeable battery packs (e.g. vibration dampening or integration of a lanyard connection).

The protective device, in particular the first housing part, is preferably connected to the housing of the machining device in such a manner that it can be released once again. Thus, the protective device may be used by both the manufacturer and the user for multiple different machining devices. For the manufacturer, this results in the advantage of being able to use as many like parts as possible, while the user can use the same protective device for different existing machining devices.

In an alternative configuration, the protective device, in particular the first housing part, is connected in a fixed manner to the housing of the electrical machining device, in particular integrally connected. As a particular advantage, this can prevent an accidental release of the protective device in the event of a fall or impact. In addition, forces may thus be better dissipated from and absorbed by the housing of the electrical machining device, if necessary. Integrally connected should be understood to mean that the housing and the protective device, in particular the first housing part, cannot be separated from one another in a non-destructive manner. Particularly preferably, the housing and the protective device, in particular the first housing part, are made of the same material.

Furthermore, it is provided that the second housing part can be mounted in the first housing part in an incrementally adjustable or continuously variable manner and can be fixed in a position by means of a locking device. Locking the second housing part on the first housing part offers the advantage that the second housing part cannot move independently. The locking device can also be configured such that it can be used to specify a minimum dimension for the at least one interchangeable battery pack to be used. This can prevent the use of replacement battery packs that do not have the required minimum power in conjunction with the machining device. In addition, the second housing part can be configured to be exchangeable, enabling customization of the machining device at the country or user level, for example, in particular by a special color or shape of the second housing part.

A tension spring is arranged between the first and the second housing part which automatically moves the second housing part, in particular after unlocking the locking device, towards a minimum dimension of the protective device. In this case, the second housing part is pressed against the spring force of the tension spring by the insertion of the at least one interchangeable battery pack into the electromechanical interface with the unlocked locking device, so that it is not necessary to move the second housing part manually again towards the at least one interchangeable battery pack. The locking device can be configured as a spring-mounted button, which automatically causes the second housing part to lock upon release. In the event of an incrementally adjustable attachment, this results in a locking in the next latching position towards the spring force. In the case of a continuously variable attachment, the locking is carried out directly at the corresponding position. As long as the user holds down the button, the second housing part can be continuously or incrementally moved against the spring force of the tension spring. If the at least one interchangeable battery pack is removed again, the tension spring causes the protective device to automatically reset to its minimum dimension. It should also be noted that the electromechanical interface is configured to receive one or more interchangeable battery packs via corresponding receptacles with a plurality of electrical contacts, in particular power and/or data contacts.

The protective device, in particular the second housing part, comprises a sensor unit for sensing the size, in particular the height, of the at least one interchangeable battery pack inserted into the electromechanical interface and/or to sense environmental and/or movement data of the machining device. In this way, if the second housing part is motorized or hydraulically driven, the at least one interchangeable battery pack inserted into the electromechanical interface can be automatically adjusted to the size sensed by the sensor unit, in particular the height. In addition, the user may set a fixed size for the at least one interchangeable battery pack to be used so that the machining device can only be operated with interchangeable battery packs of this size. Accordingly, the release to use the machining device is not granted until the sensor unit has sensed the preset size. Misuse of the machining device as a result of unauthorized removal of the second housing part by the user can also be effectively avoided. Further, the sensor unit may be used to detect vibrations or other environmental factors arising during a machining operation, such as, for example, moisture, noises, explosive gases, or the like. To detect the size of the interchangeable battery pack, the sensor unit comprises at least one sensor element in the form of a Hall sensor, an ultrasonic sensor, a light barrier, or the like. The environmental factors may be sensed by sensor elements in the form of acceleration, rotational rates or position sensors, as well as gas, air quality, moisture or temperature sensors, or the like. Communication between the sensor unit and the machining device may be conducted via cables, e.g., via the electromechanical interface for the at least one interchangeable battery pack, or wirelessly, e.g., via Bluetooth, ZigBee, or the like.

Furthermore, it is provided that an intermediate space, in particular an air gap, remains between the second housing part and the at least one interchangeable battery pack inserted into the electromechanical interface, wherein a compensating medium is arranged between the first and the second housing parts, which in the event of a fall reduces the intermediate space, in particular completely closes it. The compensating medium is preferably designed as an elastomer. Alternatively, the compensating medium may be motorized or hydraulically driven to reduce the intermediate space in case of a fall detected by the sensor unit before an impact, in particular to completely close it. The intermediate space provides the advantage of easier removal and better cooling of the at least one interchangeable battery pack. The reduction or closing of the intermediate space in the event of a fall results in improved impact protection for the at least one interchangeable battery pack and/or for the electromechanical interface, because the impact energy generated in the at least one interchangeable battery pack can not only be dissipated via the electromechanical interface but also via the second housing part of the protective device.

A further or other additional function of the protective device can be realized in that it, in particular the first housing part, comprises at least one lighting element for illuminating a work area of the machining device. The protective device is very useful for this purpose, because it is already arranged at an exposed location of the machining device, which is very good for illuminating the work area. The lighting could also be used as an indication of additional functions, such as triggered kick back control, fall detection, or the like.

Further, the protective device comprises an indicator for indicating the minimum and/or maximum possible and/or actual size of the interchangeable battery pack. It can also be used to indicate the locking position of the locking device to the user. In addition, the user can use the indicator to detect which largest possible interchangeable battery pack can be used in the respective position.

### BRIEF DESCRIPTION OF THE DRAWINGS

The disclosure is explained below with reference to FIGS. 1 through 7 by way of example, wherein identical reference numbers in the drawings indicate identical components having an identical function.

Shown are:

FIG. 1: a side view of a first exemplary embodiment of a system consisting of a battery-powered machining device in the form of a cordless drill and the protective device according to the disclosure for an interchangeable battery pack received in an electromechanical interface of the machining device,

FIG. 2a: a second exemplary embodiment of the protective device according to the disclosure for a battery-powered machining device in a maximum retracted state in a perspective view,

FIG. 2b: a second exemplary embodiment of the protective device according to the disclosure for a battery-powered machining device in a maximum extended state in a perspective view,

FIG. 3: a third exemplary embodiment of the protective device according to the disclosure in a perspective view,

FIG. 4: a fourth exemplary embodiment of the protective device according to the disclosure in a side view,

FIG. 5a: a fifth exemplary embodiment of the protective device according to the disclosure with a second housing part configured as a bracket for two interchangeable battery packs of different sizes in a side view,

FIG. 5b: a fifth exemplary embodiment of the protective device according to the disclosure with a second housing part configured as a bracket for two interchangeable battery packs of different sizes in a side view,

FIG. 6a: partial perspective view of a further exemplary embodiment of the second housing part configured as a bracket according to FIG. 5 in a maximum retracted state,

FIG. 6b partial perspective view of a further exemplary embodiment of the second housing part configured as a bracket according to FIG. 5 in a maximum extended state,

FIG. 7: a further exemplary embodiment of the second housing part of the protective device according to the disclosure configured as a cage in a perspective view, and

FIG. 8: a further exemplary embodiment of the second housing part of the protective device according to the disclosure configured as a cage in a perspective view.

### DETAILED DESCRIPTION

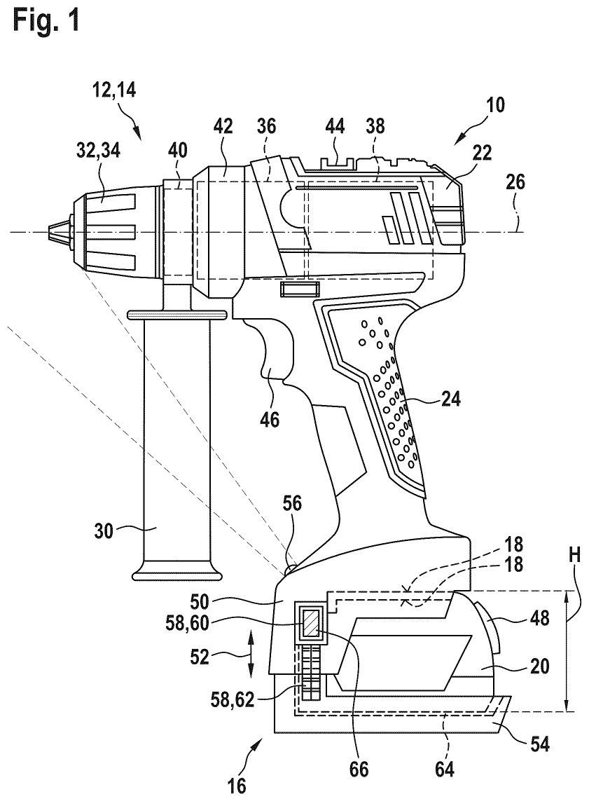

FIG. 1 shows a first exemplary embodiment of a system 10 consisting of a battery-powered machining device 12 in the form of a cordless drill 14 and a protective device 16 for an interchangeable battery pack 20 mounted in an electromechanical interface 18 of the cordless drill 14 in a side view. The protective device 16 primarily serves to protect the interchangeable battery pack 20 inserted into the electromechanical interface 18 from falls or impact. To this end, the protective device 16 surrounds the interchangeable battery pack 20 or an envelope of the interchangeable battery pack 20 such that particularly sensitive locations of the interchangeable battery pack 20 are not directly exposed to any impact energy, but rather the energy can be at least largely absorbed and dissipated by the protective device 16. The cordless drill 14 will only be described briefly below, since it is of minor importance for the disclosure as such. In addition, as already mentioned above, the disclosure can be applied to a variety of different battery powered machining devices 10.

The cordless drill 14 comprises a housing 22 having a main handle 24 in gun form and a secondary handle 26 that can be adjusted around a working axis 26 and completely detached from the cordless drill 14 without tools. A tool holder 34 configured as a quick-release chuck 32 may be clamped in a tool not shown, for example in the form of a drill. The tool holder 34 is driven via a gear box 36 by an electric motor 38, which is preferably designed as a brushless or electrically commutated DC (BLDC, EC) motor. In addition, a maximum torque can in particular be preset by the user of the cordless drill 14 for screwing operations using a locking coupling 40 and an adjustment ring 42. By means of a gear selector switch 44, it is also possible for the user to switch between two gears of the gear box 36. A spring-mounted main button 46 disposed on the main handle 24 allows the user to control the electric motor 38 such that a desired speed of the electric motor 38 and the tool receptacle 34 driven by it can be adjusted depending on the compression distance of the main button 46. The further the main button 46 is pushed into the main handle 24, the higher the speed. When the main button 46 is released, it automatically disengages and the electric motor 38 comes to a stop. The speed and/or torque control of the electric motor 38 configured as an EC motor is carried out via electronics not shown with a control unit or a power bridge, wherein the control unit drives the power bridge via pulse width modulation (PWM) such that the power bridge applies trapezoidal or near sinusoidal commutation to the individual phases of the EC motor in a known manner.

The power supply to the electronics and the electric motor 38 of the cordless drill 14 is delivered by the interchangeable battery pack 20 inserted into the electromechanical interface 18. The interchangeable battery pack 20 comprises an electromechanical interface 18 configured in a manner complementary to the electromechanical interface 18. By means of these interfaces 18, the interchangeable battery pack 20 and the cordless drill 14 can be connected to each other in a manner that is force-locking and/or positive-locking and such that they can be released. The term “releasable connection” is understood in particular to mean a connection that can be released and established without a tool, i.e., manually. In addition, a locking device 48 is provided on the interchangeable battery pack 20 by means of which the interchangeable battery pack 20 can be secured in the electromechanical interface 18 of the cordless drill 14, to prevent it from accidentally falling out. The exact configuration of the electromechanical interfaces 18 with their mechanical guide elements for the force-and/or positively locking, releasable connection and the electrical contacts used for energy and/or data transfer as well as the locking device 48 is not intended to be the subject of this disclosure. A person skilled in the art will choose a suitable embodiment for the electromechanical interface 18 depending on the power class or voltage class of the battery- operated machining device 12 and/or the interchangeable battery pack 20, so that no further details will be given here.

The voltage class of the interchangeable battery pack 20 results from the connection (parallel or serial) of the individual energy storage cells integrated in the interchangeable battery pack and is usually a whole number multiple (>=1) of the voltage of the individual energy storage cells. An energy storage cell is typically designed as a galvanic cell which has a structure in which one cell pole comes to lie at one end and a further cell pole comes to lie at an opposite end. In particular, the energy storage cell has a positive cell pole on one end and a negative cell pole on the opposite end. Preferably, the energy storage cells are designed as lithium-based button cells, e.g., Li-ion, Li-cell polymer, Li-metal, or the like, wherein the cell poles are arranged at the ends of the cylinder shape. However, the disclosure can also be applied to Ni—Cd, Ni—Mh cells or other suitable cell types. In common Li-ion energy storage cells with a cell voltage of 3.6 V, voltage classes of 3.6 V, 7.2 V, 10.8 V, 14.4 V, 18 V, 36 V, etc. are provided as examples. However, the disclosure does not depend on the type and design of the energy storage cells used, but can be applied to any interchangeable battery pack that uses prismatic cells, pouch cells or the like instead of button cells. The D.C. voltages are primarily based on the typical cell voltages of the energy storage cells being used. For pouch cells and/or cells with a different electrochemical composition, for example, voltage values are possible that differ from those of energy storage units equipped with Li-ion cells. In the following, the disclosure is described by way of example for an interchangeable battery pack 20 with a voltage class of 18 V.

The protective device 16 comprises a first housing part 50, which is integrally connected to the main handle 24 or the housing 22 of the cordless drill 14, and a second housing part 54, which is mounted in such a way that it is movable relative to the first housing part 50 along a movement direction 52. The integral connection between the first housing part 50 and the main handle 24 prevents accidental release of the protective device 16 in the event of a fall or impact. In addition, forces may be more readily dissipated in the housing 22 or the main handle 24 of the cordless drill 14. The protective device 16 and the integrally connected main handle 24 are made of the same plastic material, for example a thermoplastic Teflon, ABS, glass fiber-reinforced polyamide (PA6 GF35), or the like.

In the exemplary embodiment shown, the direction of movement 52 of the second housing part 54 extends substantially perpendicular to the working axis 26 of the cordless drill 14 for tool-free adjustment of the protective device 16 to a height H of the interchangeable battery pack 20 inserted into the electromechanical interface 18. Depending on the arrangement of the protective device 16 on the housing 22 of the battery powered tool 12 or at its electromechanical interface 18, however, other relationships between the direction of movement 52 and the working axis 26 are contemplated. Likewise, the electromechanical interface 18 may also receive two or more interchangeable battery packs 20, such that the direction of movement 52 of the second housing part 54 extends not only relative to the height H of the received interchangeable battery packs 20, but in addition or alternatively also to a width or depth of the interchangeable battery packs 20. The adaptability of the protective device 16 provides the advantage of maintaining a substantially constant enclosure independent of the interchangeable battery pack 20 used. With a smaller, interchangeable battery pack 20, it is thus possible on the one hand to keep the cordless drill 14 or the protective device 16 as compact as possible, which significantly improves ergonomics and handling, whereas on the other hand, it is possible to ensure not only good protection for the at least one interchangeable battery pack 20 against impacts and blows as a result of an improved energy distribution, but also reduce the amount of dirt (dust, moisture, etc.) to which it is exposed during the machining process. Furthermore, the protective device 16 makes it possible to reduce the package size of the cordless drill 14 during transport or storage. A useful additional function of the protective device 16 is provided by a lighting element 56 integrated in the first housing part 50 for illuminating a working area of the cordless drill 14. The lighting element 56 may be automatically activated and deactivated depending on the actuation of the main button 46 of the cordless drill 14. In addition, the lighting element 56 may be used to display additional functions, such as a triggered kick back control, fall detection, or the like, in conjunction with the electronics of the cordless drill 14.

The second housing part 54 can be incrementally latched and secured in the first housing part 50 in a certain position by way of a locking device 58, so that the second housing part 54 can no longer move independently. The locking device 58 is configured as a spring-mounted button 60 in first housing part 50, which releases a corresponding keying 62 in second housing part 54 by pressing so that second housing part 54 can move along the direction of movement 52. Upon release, the button 60 causes the second housing part 54 to lock along the keying 62.

Preferably, an intermediate space 64 remains in the form of an air gap between the second housing part 54 and the interchangeable battery pack 20 inserted into the electromechanical interface 18. The intermediate space 64 allows for easier removal and better cooling of the interchangeable battery pack 20.

In order to achieve an improved impact protection for the interchangeable battery pack 20 and/or the electromechanical interface 18, the intermediate space 64 is reduced or closed by means of a compensating medium 66, which is formed as an elastomer or a rubber damper, for example. The resulting impact energy can thus not only be dissipated via the electromechanical interface 18, but also via the second housing part 54 of the protective device 16.

The second housing part 54 may be removed from the first housing part 50 and replaced by the user of the cordless drill 14 or by a service employee as needed. This may be done either via the button 60 of the locking device 58 or via a separate mechanism. Thus, quick service is ensured in the event of damage to the second housing part 54. In addition, the protective device 16 can easily be adapted in case of manufacturer changes to the interchangeable battery pack 20 or a new battery generation, or if elements are integrated later on for changing properties of the interchangeable battery pack 20 (e.g.: vibration damping or integration of a lanyard connection). Customization of the cordless drill 14 at the country or user level, for example, is also conceivable, in particular through to a special color or shape of the second housing part 54.

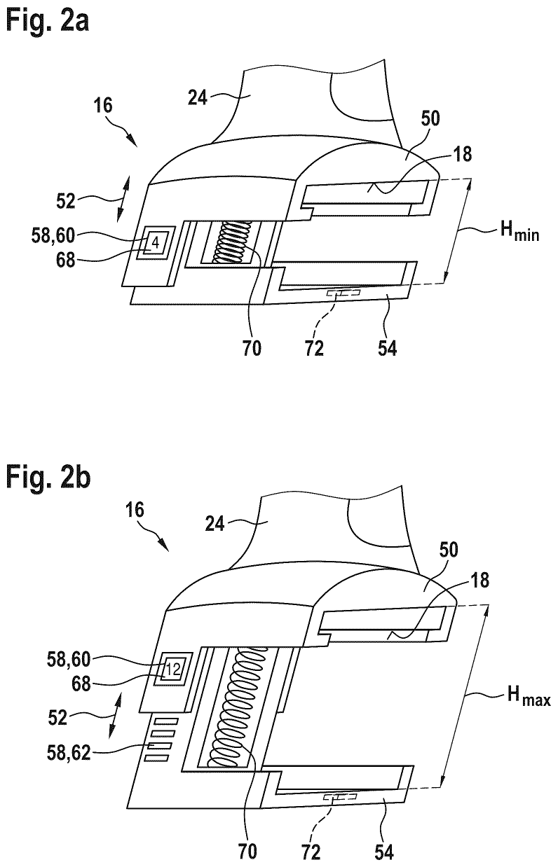

FIG. 2 shows perspective views of a second exemplary embodiment of the protective device 16 according to the disclosure for a battery-powered machining device 12. The protective device 16 is connected in a fixed manner to the main handle 24 of the machining device 12 according to FIG. 1. In FIG. 2a, the second housing part 54 of the protective device 16 is in a maximum retracted state along the direction of motion 52, while FIG. 2b illustrates the maximum extended state. The minimum possible and the maximum possible size of the removable interchangeable battery pack 20 in FIG. 2a and in FIG. 2b are displayed to the user by means of an indicator 68, which can be configured, for example, as an LC display in the button 60 of the locking device 58 or as numbers engraved in the second housing part 54 at corresponding positions, which are visible through a recess of the button 60. In this context, the size of the interchangeable battery pack 20 can also be understood to mean its charging capacity, since it is usually defined by the number of energy storage cells connected in parallel in the interchangeable battery pack 20 and thus, there is a proportionality to the height of the interchangeable battery pack 20. In the exemplary embodiment shown, in accordance with FIGS. 2a and 2b, interchangeable battery packs 20 with charging capacities of 4 to 12 Ah can be mounted via the electromechanical interface 18 of the machining device 12.

The protective device 16 comprises a tension spring 70 between the first housing part 50 and the second housing part 54, which automatically moves the second housing part 54, in particular after unlocking the locking device 58, along the direction of movement 52 towards a minimum dimension Hₘᵢₙ of the protective device 16. The minimum dimension Hₘᵢₙ is defined by a limit stop of the second housing part 54 inserted as far as possible into the first housing part 50. In the exemplary embodiment shown according to FIG. 2a, the minimum dimension Hₘᵢₙ corresponds to the overall height of the smallest removable battery pack 20 (cf. also FIG. 1). However, it is also contemplated that the second housing part 54 can be fully inserted into the first housing part 50 to achieve the smallest possible packaging dimension for the protective device 16 or the electrical machining device 12. In that case, the minimum dimension Hₘᵢₙ is less than the height of the smallest interchangeable battery pack 20. A maximum dimension Hₘₐₓ of the protective device 16 shown in FIG. 2b is analogous to the minimum dimension Hmin, taking into account the clearance 64 between the replacement battery pack 20 and the second housing part 54, where necessary (cf. FIG. 1) coupled to the largest possible interchangeable insertable battery pack 20.

In the event of an incrementally adjustable attachment, releasing the button 58 of the locking device 58 causes it to lock in the next latching position along the direction of movement 52 toward the spring force of the tension spring 70. In the case of continuously variable attachment, it is locked directly at the corresponding position. As long as the user holds down the button 60, the second housing part 54 can be continuously or incrementally moved against the spring force of the tension spring 70. The locking device 58 can also be configured such that it provides the minimum dimension of Hₘᵢₙ for the smallest interchangeable battery pack 20 to be used.

In conjunction with a sensor unit 72 integrated in the second housing part 54 for detecting the height H of the interchangeable battery pack 20 inserted into the electromechanical interface 18, it is thus possible to avoid using interchangeable battery packs 20 that do not have the required minimum power for the machining device 12. The machining device 12, for example, is not released for use until the sensor unit 72 has sensed the preset height H. Also, misuse of the machining device 12 as a result of unauthorized removal of the second housing part 54 by the user can be effectively avoided. To detect the height H of the interchangeable battery pack 20, the sensor unit 72 comprises at least one sensor element (not shown in detail) in the form of a Hall sensor, an ultrasonic sensor, a light barrier, or the like. Communication between the sensor unit 72 and the machining device 12 can be via a cable, e.g., via the electromechanical interface 18, or wirelessly, e.g., via Bluetooth, ZigBee, or the like. Further, the sensor unit 72 may be used to detect vibrations or other environmental factors arising during a machining operation, such as moisture, noise, explosive gases, or the like.

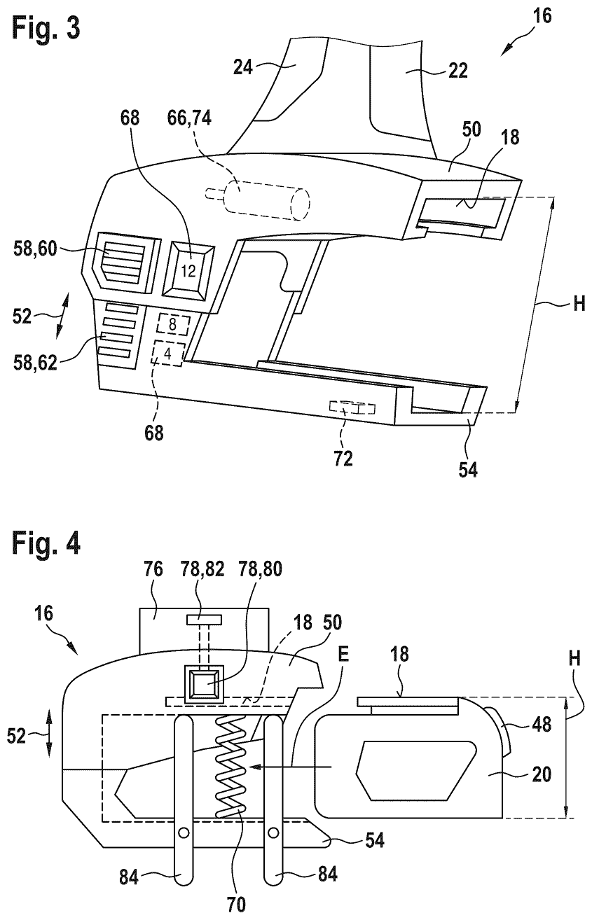

FIG. 3 shows a perspective view of the protective device 16 according to a third exemplary embodiment of the disclosure. The first significant difference from the two previous exemplary embodiments is that the second housing part 54 is driven by an electric motor 74 arranged in the first housing part 50. The second significant difference is that the indicator 68 is configured separately from the locking device 58 as a window disposed in the first housing part 50 with numbers printed or engraved in the second housing part 54 corresponding to the charging capacity of the interchangeable battery pack 20 that can be inserted or pushed into the electromechanical interface 18. The motor drive of the second housing part 54 can automatically adjust to the height H of the interchangeable battery pack 20 inserted into the electromechanical interface 18 detected by the sensor unit 72. If the user presses the button 60 of the locking device 58, the second housing part 54 is first moved to the maximum extended position so that the user can insert the interchangeable battery pack 20 into the electromechanical interface 18. If the user subsequently presses the button 60 again, the second housing part 54 approaches the minimum dimension Hₘᵢₙ along the direction of movement 52 and stops automatically once the sensor unit 72 sends a corresponding signal to the electric motor 74. It is also contemplated that the user can set a fixed height H for the interchangeable battery pack 20 to be used, so that the machining device 12 can only be operated with interchangeable battery packs 20 of this height H. With reference to the intermediate space 64 mentioned in FIG. 1 between the interchangeable battery pack 20 and the second housing part 54, the compensating medium 66 may also be realized by the electric motor 74 to reduce or completely close the intermediate space 64 in the event of a fall detected by means of the sensor unit 72 prior to an impact.

FIG. 4 shows a fourth exemplary embodiment of the protective device 16 according to the disclosure in a side view. In contrast to the previous exemplary embodiments, the protective device 16 can be connected to the machining device 12 not shown in such a manner that it can be released. Therefore, it is preferably purely mechanically formed. To be connected to the machining device 12 in such a way that it can be released, a flange 76 is provided on the first housing part 50, which can be inserted into a corresponding housing opening of the housing 22 of the machining device 12. The protective device 16 is captively fixed in the housing recess by means of a locking device 78. To this end, the user can press a spring-mounted button 80, which engages a catch lug 82 in the flange 76. If the user releases the button 80, the catch lug 82 automatically disengages as a result of the spring force and in the state inserted into the housing opening, causes the catch lug 82 to engage a corresponding recess of the housing opening. Instead of the locking device 78, which can be operated by the user via the button 80, a locking device 78 which can be disconnected only by the manufacturer by means of a special tool can also be provided.

The protective device 16 according to the exemplary embodiment in FIG. 2 comprises a tension spring 70, which pulls or closes the second housing part 54 towards the minimum dimension Hₘᵢₙ of the protective device 16. If the user pushes the interchangeable battery pack 20 with its electromechanical interface 18 into the corresponding mating interface 18 of the protective device 16, the second housing part 54 is opened along the direction of movement 52 with the help of lateral guide elements 84 arranged on the first housing part 50, contrary to the spring force of the tension spring 70. If the interchangeable battery pack 20 is removed again, the protective device 16 automatically closes in the direction of its minimum dimension Hₘᵢₙ again due to the spring force of the tension spring 70.

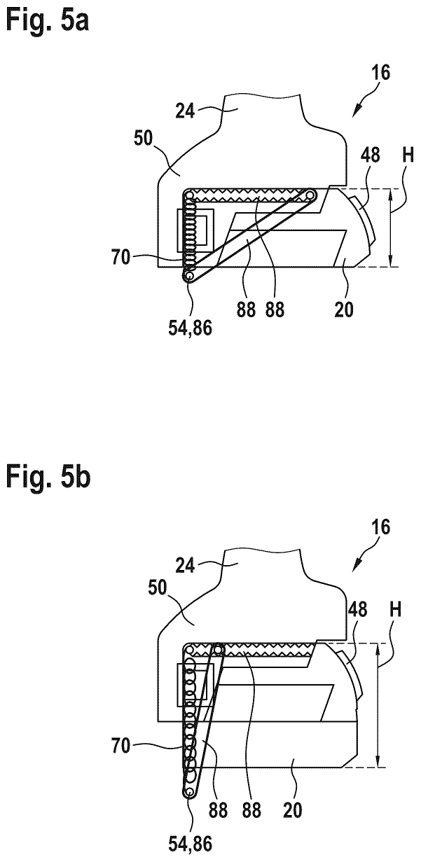

In FIG. 5, a further embodiment of the protective device 16 according to the disclosure is shown for a smaller interchangeable battery pack 20 (FIG. 5a) and a larger interchangeable battery pack (FIG. 5b) each in a side view. Instead of enclosing the removable battery pack 20 or its envelope more or less completely, the protective device 16 here only protects locations of the inserted removable battery pack 20, for example the electromechanical interface 18, which are particularly sensitive to falls and impacts. To this end, the second housing part 54 is configured as a bracket 86 that is extended via an adjustment mechanism 88 upon insertion of the interchangeable battery pack 20 into the electromechanical interface 18 of the protective device 16. The adjustment mechanism 88 extends the bracket 86 differently depending on the height H of the interchangeable battery pack 20 and thus protects the “critical locations” of the interchangeable battery pack 20. By means of a tension spring 70, the bracket 86 automatically retracts back towards its minimum dimension of Hₘᵢₙ after the replacement battery pack 20 has been removed. The bracket 86 is preferably made of a metal (steel, aluminum, etc.). However, it is also conceivable that a plastic or a mix of materials consisting of plastic and metal (e.g., a metal bracket 86 overmolded by a plastic) may be used.

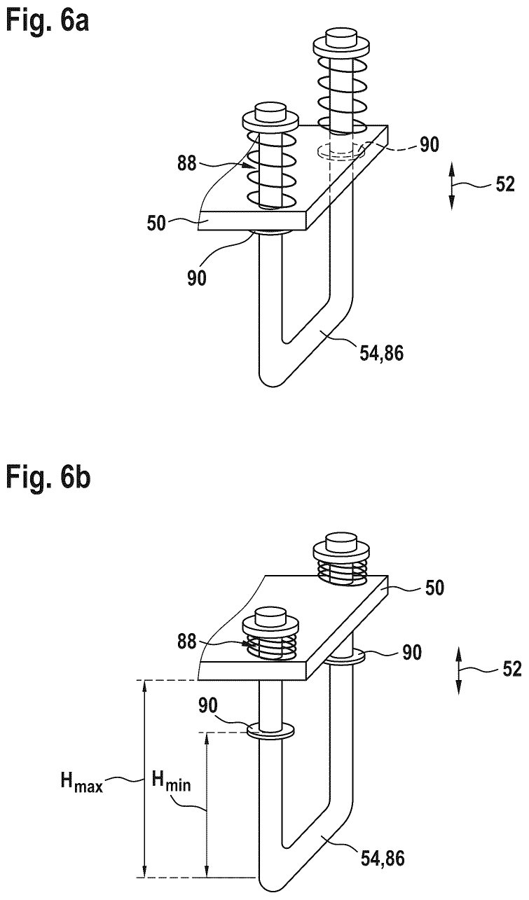

FIG. 6 shows highly simplified partial perspective views of a further exemplary embodiment of the second housing part 54 configured as bracket 86 according to FIG. 5. In FIG. 6a, the bracket 86 is in a maximum retracted state while FIG. 6b shows the bracket 86 in a maximum extended state. For the sake of clarity, illustrations of all further parts of the protective device 16 were omitted. In this regard, please refer to FIG. 5. The bracket 86 is automatically pushed in the direction of the minimum dimension Hₘᵢₙ defined by a stop 90 provided on the bracket 86 by means of a compression spring 88. The stop 90 in the exemplary embodiment shown is configured as a plurality of rings, which are preferably adjustable along the direction of movement 52 of the bracket 86 to adjust the minimum dimension Hₘᵢₙ. However, the stop 90 can also be connected to the bracket 86 in a fixed manner, so that the minimum dimension Hₘᵢₙ can only be changed by exchanging the bracket 86, which can in particular be carried out by the manufacturer. When the interchangeable battery pack 20 is inserted into the electromechanical interface 18 of the protective device 16, this pushes the bracket 86 towards the maximum dimension Hₘₐₓ, contrary to the spring force of the compression spring 88. If the interchangeable battery pack 20 is removed, the bracket 86 moves back towards the minimum dimension Hₘᵢₙ as a result of the spring force.

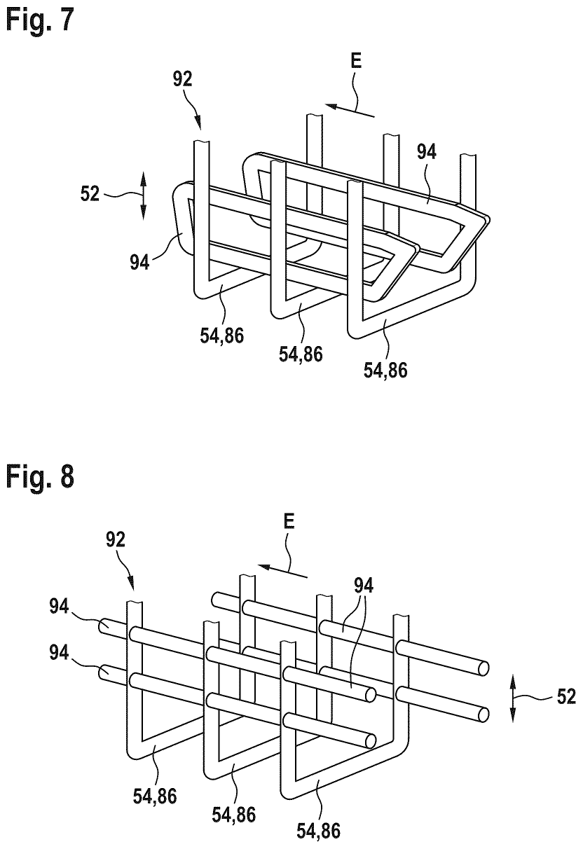

FIGS. 7 and 8 show two further exemplary embodiments of a second housing part 54 configured as cage 92 in perspective views. Essentially, the two cages 92 shown each consist of a plurality of spaced brackets 86 along the insertion direction E of the interchangeable battery pack 20, which are fixed by laterally arranged transverse struts 94. The cages 92 are preferably made of a metal (steel, aluminum, etc.). However, it is also conceivable that a plastic or a mix of materials consisting of plastic and metal may be used. Shapes, such as a plastic tub, a frame structure open at the bottom, or a combination thereof, are also contemplated for the second housing part 54 instead of a cage 92.

Finally, it should be pointed out that the exemplary embodiment shown is not limited to FIGS. 1 through 8 or to the size proportions shown. In addition, the protective device 16 according to the disclosure can also be used for battery-powered machining devices 12 with an electromechanical interface 18, which can receive two or more interchangeable battery packs 20.

What is claimed is:

1. A protective device for at least one interchangeable battery pack of a battery powered machining device, wherein the machining device comprises a housing and an electromechanical interface disposed on the housing for mounting the at least one interchangeable battery pack without tools, and wherein the protective device is arranged on the electromechanical interface in such a way that it at least partially surrounds the interchangeable battery pack in conjunction with the housing of the machining device, comprising:
at least one housing part, wherein the protective device is configured to be adjusted to a height of the at least one interchangeable battery pack without tools.

2. The protective device according to claim 1, wherein a minimum dimension for the height of the at least one interchangeable battery pack is specified depending on a performance capacity of the machining device.

3. The protective device according to claim 1, wherein:
the at least one housing comprises a first housing part configured to be connected to the housing of the machining device, and a second housing part configured to be mounted in a movable manner relative to the first housing part.

4. The protective device according to claim 3, wherein the first housing part is configured to be connected to the housing of the machining device in a releasable manner.

5. The protective device according to claim 3, wherein the first housing part is integrally connected in a fixed manner to the housing of the battery powered machining device.

6. The protective device according to claim 3, wherein the second housing part is configured to be mounted in the first housing part in an incrementally adjustable or continuously variable manner, and is configured to be fixed in a first position by a locking device.

7. The protective device according to claim 6, wherein:
a tension spring is arranged between the first and the second housing parts; and
the tension spring is configured to move the second housing part, after unlocking the locking device with the second housing part in the first position, automatically toward a minimum dimension of the protective device.

8. The protective device according to claim 3, wherein the second housing part comprises a sensor unit configured to sense a height of the at least one interchangeable battery pack inserted into the electromechanical interface and/or of environmental and/or movement data of the machining device.

9. The protective device according to claim 8, wherein the second housing part is motorized or hydraulically driven and is automatically adjusted based upon the height of the at least one interchangeable battery pack inserted into the electromechanical interface.

10. The protective device according to claim 6, wherein:
in the first position there remains an air gap between the second housing part and the at least one interchangeable battery pack; and
a compensating medium is arranged between the first and the second housing part which in the event of a fall reduces the air gap.

11. The protective device according to claim 10, wherein the compensating medium is formed as an elastomer.

12. The protective device according to claim 10, wherein:
the second housing part comprises a sensor unit; and
the compensating medium is motorized or hydraulically powered and completely closes the air gap in the event of a fall detected by the sensor unit prior to an impact.

13. The protective device according to claim 3, wherein the first housing part comprises at least one lighting element configured to illuminate a work area of the machining device.

14. The protective device according to claim 1, wherein the protective device comprises an indicator configured to display a minimum and/or a maximum possible and/or actual height of the interchangeable battery pack.

15. A system comprising:
the protective device according to claim 1; and
a battery powered machining device.
